(19) United States
(12) Patent Application Publication
(10) Pub. No.: US 2011/0254697 A1
(43) Pub. Date: Oct. 20, 2011

(54) Utility Monitoring

(75) Inventors: Steven M. Casey, Littleton, CO (US); Bruce A. Phillips, Frederick, CO (US)

(73) Assignee: QWEST COMMUNICATIONS INTERNATIONAL INC., Denver, CO (US)

(21) Appl. No.: 13/090,006

(22) Filed: Apr. 19, 2011

Related U.S. Application Data
(60) Provisional application No. 61/326,092, filed on Apr. 20, 2010.

(51) Int. Cl. G08C 15/06

(52) U.S. Cl. 340/870.02

(57) ABSTRACT

Novel tools and techniques that can allow utility customers, utility providers, and/or other parties to more effectively monitor utility usage at a customer premises utilizing utility monitoring devices, systems, and methods. A utility monitoring device might provide real time (or non-real time) data regarding utility usage for one or more different types of utilities, such as natural gas, electricity, and/or water, to name but a few examples. In some cases, a utility monitoring device can receive and/or process usage data directly from a utility meter (and/or might be incorporated within a utility meter). In other cases, such a device can receive and/or process data from smart appliances, smart power distribution devices, etc. Utility monitoring devices in accordance with various embodiments can send and/or receive using a variety of techniques and/or media, including without limitation via a broadband network, via a wireless network, and/or the like.

### CROSS-REFERENCES TO RELATED APPLICATIONS

This application claims the benefit, under 35 U.S.C. §119(e), of co-pending provisional U.S. Patent Application No. 61/326,092 filed Apr. 20, 2010 by Casey and titled “Utility Monitoring,” which is hereby incorporated by reference, as if set forth in full in this document, for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to the collection and transmission of utility data, and more particularly, to a techniques and devices for monitoring utility usage at a premises and providing data on such usage to a variety of parties.

### BACKGROUND

Traditional utility meter reading has involved a utility company sending a technician out to a customer premises to visually read the utility meter. Radio frequency technology has made the process somewhat easier by allowing a technician to drive through a neighborhood with a radio receiver and gather utility meter readings that are transmitted over a radio frequency from the utility meter to the technician's receiver. Both of these techniques may involve substantial human interaction, resulting in increased cost and decreased convenience. Moreover, neither of these methods is amenable to real-time meter reading.

At the same time, technologies have developed to allow utility customers to monitor and manage different devices and appliances within their homes. However, these technologies often are limited to individual users implementing their own Home Automated Networks using private Home Networking mechanisms such as X10, Z-Wave, and Zigbee. To date, however, such technologies have been typically implemented on an individual scale and often don't benefit from centralized monitoring and/or management capabilities; further, because there may be no interface between such technologies and current information about utility rates, the potential benefits of such technologies have not been maximized.

There may, therefore, be a need for tools and techniques that allow utility providers to collect meter readings without a technician having to visit a customer premises. It would be advantageous, in some situations, for such tools and techniques to provide monitoring, managing, and controlling of device usage in the home. There may also be a need for tools and techniques that allow utility customers themselves, or other parties in some cases, to receive the utility usage data, which may be processed and presented to them in a variety of different ways. It would be advantageous, in some situations, for such tools and techniques to provide monitoring, managing, and controlling of device usage in the home.

### BRIEF SUMMARY

Certain embodiments thus provide tools and techniques that may allow utility customers, utility providers, and/or other parties to more effectively monitor utility usage at a customer premises utilizing utility monitoring devices, systems, and methods. The utility monitoring device, for example, may replace the need for a technician or other individual to visit a customer premises to make determinations of utility usage. A utility monitoring device may provide real time data regarding utility usage for one or more different types of utilities, such as natural gas, electricity, and/or water, to name but a few examples. In some cases, a utility monitoring device can receive and/or process usage data directly from a utility meter (and/or might be incorporated within a utility meter). In other cases, such a device can receive and/or process data from smart appliances, smart power distribution devices, etc. Utility monitoring devices in accordance with various embodiments can send and/or receive using a variety of techniques and/or media, including without limitation via a broadband network, via a wireless network, and/or the like.

The utility usage data may be processed to provide additional information to utility customers, utility providers, and/or other parties. The processed utility usage data may be presented in different ways, making the data more useful to the parties that may receive it. Utility monitoring devices and related systems and methods may also provide reports, alerts, and other functions that may enhance how different parties may be able to use the utility usage data and make decisions regarding utility usage or control utility usage. Some utility monitoring devices, systems, and methods may also include a variety of specific modules, including but not limited to, data security modules, utility usage presentation modules, utility control and regulation-based modules, utility rule engine modules, and/or utility buy-back and/or sell-back modules.

Embodiments may include methods for monitoring utility usage using a utility monitoring device. The methods may include receiving utility usage data at the utility monitoring device transmitted from a metering device at a premises of a utility user. The utility usage data may be stored on a memory coupled with the utility monitoring device. The utility usage data may be processed using a processor coupled with the memory coupled with the utility monitoring device. The processed utility usage data may be transmitted from the utility monitoring device to at least one receiving device.

In some embodiments, methods for monitoring utility usage using a utility monitoring device may include at least one receiving device that is a device of the utility user. The receiving devices can include devices such as a personal computer, a cell phone, a mobile phone data device, a personal digital assistant (PDA), a telephone, or a television. Some embodiments of methods for monitoring utility usage using a utility monitoring device may include transmitting the utility usage data from the utility monitoring device to a modem and/or a network interface device. Transmitting the processed utility usage data may include transmitting the utility usage data through at least a public or private network to the at least one receiving device. Some embodiments may further include receiving instructions at the utility monitoring device from the utility user designating the device of the utility user to transmit the processed utility usage data to and also storing the instructions in the memory.

Some embodiments of methods for monitoring utility usage using a utility monitoring device may include processing the utility usage data to format the utility usage data for presentation on the at least one receiving device. Processing the utility usage data may also include determining a trend in the utility usage data. Some embodiments may also include receiving pricing information regarding the utility usage at the utility monitoring device along with transmitting the pricing information to the at least one receiving device.

Some embodiments of methods for monitoring utility usage using a utility monitoring device may include transmitting the utility usage data and/or the processed utility usage data to a third party based on instructions received from the utility user at the utility monitoring device. The third party may include a utility provider or any other entity with whom sharing such information may be appropriate. Some embodiments may include transmitting an alert to the receiving device based on the utility usage data.

Some embodiments may include a utility monitoring device for monitoring, processing, and presenting utility usage of a utility user. A utility monitoring device may include a variety of components including a housing, an interface for receiving utility usage data from the utility user, a memory included within the housing, wherein the memory stores utility usage data received from a metering device of the utility user, a processor coupled with the memory for processing the utility usage data, and an interface for transmitting the processed utility usage data to a receiving entity device.

In some embodiments, at least one of the interfaces for receiving utility usage data or the interface for transmitting the process utility usage data may include a wireless interface. The interface for transmitting the processed utility usage data may be configured to couple with at least a modem or a network interface device. In some embodiments, the utility monitoring device may also include different modules such as a device control module, a data presentation module, a utility usage module, a data security module, an automatic usage rule engine module, and/or a utility price monitoring module.

Some embodiments may include a system for monitoring utility usage of a utility user using a utility monitoring device. The system may include a metering device. The system may include a transmission device in communication with the metering device. The transmission device may be configured to transmit utility usage data from the metering device. The system may include a utility monitoring device. The utility monitoring device may be in communication with the transmission device to receive, to store, and to process the utility usage data. The system may include a broadband modem and/or other communication facility in communication with the utility monitoring device. The communication facility may be configured to communicate with a service provider's access network and to transmit utility usage data from the utility monitoring device to a receiving entity device.

In some embodiments, the system for monitoring utility usage using a utility monitoring device may involve a receiving entity device that includes a device of the utility user. In some embodiments, the utility monitoring device may be further configured to format the utility usage data for presentation on the receiving entity device. In some embodiments, the utility monitoring device may be further configured to process the utility usage data to determine a trend in the utility usage data. In some embodiments, the utility monitoring device may be further configured to receive pricing information through the broadband modem and transmit the pricing information to the receiving entity device. The utility monitoring module may be further configured to transmit the utility usage data to a third party based on instructions received from the utility user at the utility monitoring device. In some embodiments, the third party may include a utility provider.

The tools provided by various embodiments include, without limitation, methods, systems, and/or software products. Merely by way of example, a method might comprise one or more procedures, any or all of which are executed by a utility monitoring device, a computer system, and/or the like. Correspondingly, an embodiment might provide a computer system configured with instructions to perform one or more procedures in accordance with methods provided by various other embodiments. Similarly, a computer program might comprise a set of instructions that are executable by utility monitoring device or a computer system (and/or a processor therein) to perform such operations. In many cases, such software programs are encoded on physical, tangible and/or non-transitory computer readable media (such as, to name but a few examples, optical media, magnetic media, and/or the like).

Merely by way of example, a system in accordance with one set of embodiments comprises a monitoring device (which might be a utility monitoring device). In an aspect, the monitoring device can provide utility monitoring services. In an embodiment, the utility monitoring device comprises a first communication interface, a first processor in communication with the first communication interface, and/or a first memory in communication with the first processor.

The first memory might have stored therein a first set of machine readable code executable by the monitoring device to perform one or more operations. Merely by way of example, the machine readable code might comprise code for receiving, a first set of utility usage information, and/or code for processing the utility usage information. The memory might have stored therein code for providing at least a portion of the processed utility usage information to a subscriber of the utility and/or code for providing at least a portion of the utility usage information to a provider of the utility.

In accordance with some embodiments, the system might further comprise a smart power distribution device in communication with the monitoring device. The smart power distribution device might comprise an electrical input interface configured to receive electricity from a standard electrical wall socket and one or more electrical output interfaces configured to provide electricity to one or more client devices, e.g., via standard electrical plugs. The smart power distribution device, in an embodiment, further comprises a second communication interface configured to provide communications with the monitoring device, a second processor in communication with the second communication interface, and/or a second memory in communication with the second processor. The second memory might have stored therein a second set of machine readable code executable by the second processor to cause the smart power distribution device to perform one or more operations.

Merely by way of example, the second set of machine readable code can comprise code for measuring electrical usage of at least one of the one or more client devices; code for reporting, via the communication interface, the measured electrical usage of the at least one of the one or more client devices; code for receiving, via the communication interface, instructions on operation of the at least one of the one or more client devices; and/or code for controlling an electrical current supplied to at least one of the one or more electrical output interfaces, in response to the instructions.

Other embodiments might comprise a monitoring device or a smart power distribution device, including without limitation devices such as those described above. Merely by way of example, a monitoring device in accordance with another set of embodiments might comprise a communication interface, a processor in communication with the communication interface, and a memory in communication with the processor, the memory having stored therein a set of machine readable code executable by the device to perform one or more operations. In an exemplary embodiment, the machine readable code might comprise code for receiving, from a utility meter, a first set of utility usage information and/or code for processing the utility usage information. The memory might further have code for providing at least a portion of the processed utility information to a subscriber of the utility, code for providing at least a portion of the utility usage information to a provider of the utility, and/or code for providing at least a portion of the utility usage information to a third party separate from the subscriber and the provider.

Other embodiments provide methods. An exemplary method of utility monitoring might comprise receiving, from a utility meter, a first set of utility usage information; processing the utility usage information at a utility monitoring device; providing at least a portion of the processed utility information to a subscriber of the utility; providing at least a portion of the utility usage information to a provider of the utility; and/or providing at least a portion of the utility usage information to a third party separate from the subscriber and the provider.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a system for monitoring utility usage of a utility user using a utility monitoring device, in accordance with various embodiments;

FIG. 2 illustrates a schematic of a utility monitoring device, in accordance with various embodiments;

FIG. 3 illustrates a block diagram for methods of monitoring utility usage using a utility monitoring device, in accordance with various embodiments;

FIG. 4 illustrates a system for monitoring utility usage of a utility user using a utility monitoring device that includes data security module(s), in accordance with various embodiments;

FIG. 5 illustrates a system for monitoring utility usage of a utility user using a utility monitoring device that includes utility usage presentation module(s), in accordance with various embodiments;

FIG. 6 illustrates a system for monitoring utility usage of a utility user using a utility monitoring device that includes utility control regulation module(s), in accordance with various embodiments; and

FIG. 7 illustrates a system for monitoring utility usage of a utility user using a utility monitoring device that includes utility sell-back and/or buy-back module(s), in accordance with various embodiments;

FIG. 8 illustrates a smart power distribution device, in accordance with various embodiments;

FIG. 9 illustrates a method that can be implemented by a smart power distribution device, in accordance with various embodiments; and

FIG. 10 is a generalized schematic diagram illustrating a computer system, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Some embodiments might involve one or more operations that can be described as a process and/or depicted as a flowchart, a flow diagram, a data flow diagram, a structure diagram, or a block diagram. Although such descriptions and depictions might characterize the operations as a sequential process, many of the operations can be performed in parallel or concurrently. In addition, the order of the operations may be rearranged from the depicted organization unless the context specifically indicates otherwise. A process may be terminated when its operations are completed, but alternatively might comprise additional operations not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be encoded on a computer readable medium (which can be non-transitory, in some cases). A processor(s) may perform the necessary tasks and/or may cause other components of a computer system to perform such tasks, in response to the instructions (e.g., program code) on the medium.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Certain embodiments provide tools and techniques that may allow utility customers, utility providers, and/or other parties to more effectively monitor utility usage at a customer premises utilizing utility monitoring devices, systems, and methods. The utility monitoring device, for example, may replace the need for a technician or other individual to visit a customer premises to make determinations of utility usage. A utility monitoring device may provide real time data regarding utility usage for different types of utilities. This data (referred to herein as “utility usage data” and “utility usage information” can comprise any information about usage of monitored utilities, including without limitation natural gas, electricity, water, telephone service, television service, broadband Internet service, and/or the like, and can include, merely by way of example, information about the quantity of the utility used or consumed, information about the rate of use, information about the unit price or rate of the utility, information about the time period of use, and/or the like). This utility usage data may be processed to provide additional information to utility customers, utility providers, and/or other parties. The processed utility usage data may be presented in different ways, making the data more useful to the parties that may receive it. Utility monitoring devices and related systems and methods may also provide reports, alerts, and other functions that may enhance how different parties may be able to use the utility usage data and make decisions regarding utility usage or control utility usage. Some utility monitoring devices, systems, and methods may also include a variety of specific modules, including but not limited to, data security modules, utility usage presentation modules, utility control and regulation-based modules, utility rule engine modules, and/or utility buy-back and/or sell-back modules.

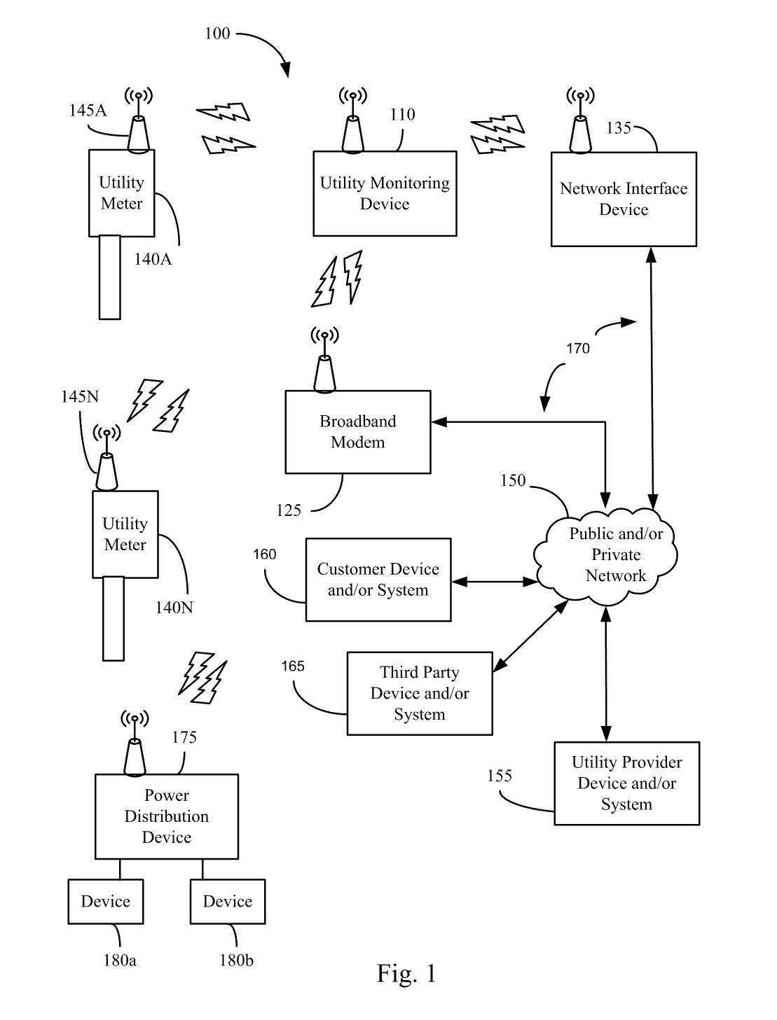

FIG. 1 shows an embodiment of a system 100 for transmitting and processing utility usage data and/or receiving utility control, monitoring, and maintenance data using a service provider's access network. System 100 includes utility monitoring device (“UMD”) 110. Utility monitoring device 110 may be used to monitor utility usage for a single customer premises or multiple premises. Utility monitoring device 110 may receive utility usage data from utility meter(s) 140A-N. Utility meters 140A-N may be in communication with wireless modules 145A-N, respectively, in order to transmit utility usage data to a receiver, such as a receiver used by a utility company that gathers data by sending a technician through a neighborhood to gather utility meter readings. In one embodiment, utility monitoring device 110 receives utility usage data from utility meters 140A-N and may then transmit it to another device capable of connecting to a network, such as Public and/or Private Network 150. Utility monitoring device 110 may transmit utility usage data to broadband modem 125, which may then transmit modulated utility usage data to utility provider device and/or system 155 via Public and/or Private Network 150. In some embodiments, utility monitoring device 110 may transmit utility usage data to network interface device (“NID”) 135, which may also transmit utility usage data to utility provider device and/or system 155 via Public and/or Private Network 150, which can be a wired network, a wireless network (e.g., a WLAN, WWAN, etc.), and/or a combination of each. In other cases, the utility monitoring device 110 might be incorporated within (or might comprise) a NID 135, or another device, such as a television set-top box (e.g., a cable television receiver, a satellite receiver, etc.), a broadband modem, and/or the like. In some embodiments, utility usage data may be sent to customer device and/or system 160 and/or third party device and/or system 165.

Utility monitoring device 110 may be coupled with utility meter 140 in some embodiments via a wireless (e.g., WLAN) and/or wired (e.g., Ethernet, HPNA, USB, etc.) connection. Similarly, in other embodiments, utility monitoring device 110 may be coupled with broadband modem 125 or NID 135 via a wireless and/or wired connection. an Ethernet/USB cable. In still other embodiments, utility monitoring device 110 may be built into broadband modem 125 or NID 135.

In some embodiments, a separate utility monitoring device 110 may be provided for each utility and/or service provider. Thus, there may be multiple utility monitoring device 110 associated with a customer premises. In other embodiments, utility monitoring device 110 may be a central utility monitoring device capable of aggregating utility usage data from multiple types of utility use associated with different utility providers, such as electricity, natural gas, telephone service, television service (e.g., cable television service, satellite television service, etc.), broadband internet service, and/or the like.

In some embodiments, utility monitoring device 110 may do more than receive data from utility meters like 140. Utility monitoring device 110 may be capable of transmitting data and/or instructions to utility meter 140. Utility monitoring device 110 may, for example, transmit control data received from utility provider device and/or system 155, customer device and/or system 160, and/or third party device and/or system 165, through either broadband modem 125 or NID 135, to utility meter 140. Control data may be used to control, monitor, or maintain devices in communication with utility meter 140. In some embodiments, this may be achieved through a power line communications network in communication with utility meter 140.

Utility monitoring device 110 may also facilitate how frequently utility usage data is transmitted through the system. Data may be transmitted automatically without human input. Data may be transmitted on a regular schedule, such as every second, every minute, every hour, every day, and/or every month, or based on specific numerical increments of these time units. Data may be transmitted in real-time. Data may be transmitted based on other factors, such as when the utility usage changes, such as when the utility usage goes up or goes down, and/or when a specific device is used. Data may be transmitted when queried by another device, server, entity, and/or user. Data may be transmitted when the cost of utility usage changes. Merely by way of example, if the cost of electricity, gas, and/or water changes, the rate or timing of data transmission may change, which may allow a utility provider to charge more accurately a customer based on when and how to use a utility. Also, the rate or timing of data transmission may also be determined to help provide a user of the utility, such as a utility customer, more information so that they may be better able to monitor and control their utility usage. Data may also be transmitted when the data collecting device receives a prompt sent by a receiving entity.

Utility monitoring device 110 may transmit utility usage data securely using methods disclosed above, for example.

Certain embodiments may include using a public switched telephone network (“PSTN”) 170 that may be in communication with utility monitoring device 110. PSTN 170 may include local loops or subscriber lines that may be physical links or circuits that connect from a demarcation point of a customer premises to a service provider's network. A local loop may be provisioned to support data communications applications. A local loop may be provisioned to support combined voice and data such as a digital subscriber line (“DSL”). The methods and systems may include collecting utility usage data pertaining to a customer premises with utility meter 140 at the customer premises. The utility usage data may be transmitted automatically from utility meter 140 to a utility monitoring device 110, which may be in communication with Public and/or Private Network 150. The utility usage data may be received at the utility monitoring device 110. DSL modem, such as broadband modem 125, in communication with the utility monitoring device 110 may modulate the utility usage data. The utility usage data may be transmitted securely through the PSTN 170 to Public and/or Private Network 150. The utility usage data may be received at Public and/or Private Network 150. The utility usage data may be transmitted from Public and/or Private Network 150 to different receivers, such as the customer device and/or system 160, a utility provider device and/or system 155, and/or a third party device and/or system 165 via Public and/or Private Network 150, via a virtual private network (“VPN”), and/or via a private line, among other possibilities.

Embodiments may include methods and systems for transmitting utility usage data using a service provider's access network. Methods and systems may include collecting utility usage data with a data collecting device, such as utility meter 140. The utility usage data may be transmitted from the data collecting device 145 to a utility monitoring device 110 coupled with a broadband modem 125 or network interface device 135. The utility usage data may be received at the utility monitoring device 110. The utility usage data may be transmitted from the utility monitoring device 110 to a receiving entity 155, 160, and/or 165 through the service provider's access network. A receiving entity may include, but is not limited to, a customer, a utility provider, a government entity, and/or a third party, merely by way of example.

A data collecting device may include a wide variety of devices, including without limitation a utility meter, such as an electricity meter, a gas meter, and/or a water meter. The utility monitoring device 110 and/or the utility meter 140 may collect data regarding customer premises equipment (“CPE”), including without limitation data regarding smart devices (not shown) and therefore can serve as data collecting devices. Merely by way of example, smart devices may include any devices, outlets, appliances, and/or equipment that may be capable to sending or receiving information in order to facilitate monitoring, maintaining, and/or controlling the smart device. In a particular embodiment. a smart power distribution device 175 (described in more detail below) can serve as a smart device to provide utility usage information about one or more non-smart devices 180 that consume a utility (such as electricity) through the smart power distribution device 175. A data collecting device may include, but not be limited to, such things as a set-top box or a network interface device. A data collecting device may include a computer, capable of gathering, storing, and/or transmitting data regarding utility usage. In some cases, a data collecting device may be a dedicated device for collecting utility usage data from a variety of devices within a particular premises; such a device may be (but need not necessarily be) incorporated within and/or in communication with the utility monitoring device 110 and/or the utility meter 140.

A data collecting device, such as the utility monitoring device 110 and/or the utility meter 140 merely by way of example, may be in communication with a power line communications (“PLC”) network (not shown). A PLC network may include any system in which data is transmitted over power lines, which may include without limitation relatively high-voltage transmission lines, medium voltage distribution lines, and lower voltage lines used inside buildings. PLC may include, inter alia, systems referred to in the art as power line carrier, power line digital subscriber line, mains communication, power line telecom, and/or power line networking. PLC may be a system for carrying data on a conductor also used for electric power transmission. PLC may include impressing a modulated carrier signal on a wiring system to convey information along the wiring system. In some embodiments, a PLC network may provide Internet access to devices connected to the PLC network. A PLC network may also be used to query and send commands to smart devices, enabling them to be remotely monitored, controlled, and/or maintained by servers in a network. A user of the smart devices may also be able to monitor, control, and/or maintain different devices using a PLC network. A PLC network may also comprise and/or be bridged to a Home Network. This may effectively expand the Home Network to include data capabilities over the AC power lines in a customer premises.

A data collecting device, such as the utility monitoring device 110 and/or utility meter 140, may be attached to the exterior wall of a customer premises. In some embodiments, a data collecting device may be located within a customer premises or remotely from a customer premises. In some embodiments, a data collecting device may be coupled with a utility monitoring device 110 and/or the functionality of the data collecting device can be incorporated by the utility monitoring device 110 itself. Some embodiments that include a data collecting device coupled with a utility monitoring device may receive utility usage data using a variety of technologies, including, but not limited, to Encoder Receiver Transmitter (“ERT”) and/or other wireless technologies.

Utility usage data may include a wide variety of data, including without limitation electricity usage data, water usage data, gas usage data, and/or smart device utility usage data. Usage data can include, for example, information about a quantity of electricity, water, gas, etc. used, information about a rate of use, information about a time period of use, and/or the like. In a particular example, a set of utility usage data might specify that a customer premises had consumed a particular volume (or mass) of natural gas over a particular time period (such as 12:00 am to 6:00 am on a particular date). In some embodiments, utility usage data may be transmitted from a single customer premises to a remote terminal, while in other embodiments, utility usage data may be transmitted from multiple customer premises to a remote terminal.

Utility usage data may be transmitted from a data collecting device (such as a utility monitoring device 110 and/or utility meter 140 merely by way of example) in many different ways, including without limitation being transmitted automatically without human input. Data may be transmitted on a regular schedule, such as every second, every minute, every hour, every day, and/or every month, or based on specific numerical increments of these time units. Data may be transmitted in real-time. Data may be transmitted based on other factors, such as when the utility usage changes and/or on demand. For example, when the utility usage goes up or goes down and/or when a specific device is used, data may be transmitted in some embodiments. Data may be transmitted when queried by another device, server, entity, and/or user. Data may be transmitted when the cost of utility usage changes. Merely by way of example, if the cost of electricity, gas, and/or water changes, the rate or timing of data transmission may change, which may allow a utility provider to charge more accurately a customer based on when and how they use a utility. Also, the rate or timing of data transmission may also be determined to help provide a user of the utility, such as a utility customer, more information so that they may be better able to monitor, maintain, and/or control their utility usage. Data may also be transmitted when the data collecting device receives a prompt sent by a receiving entity.

As noted above, Utility monitoring device 110 may receive utility usage data from a data collecting device and/or may serve as a data collecting device. Utility monitoring device 110 may include a communication interface (such as a modem in some embodiments, which may modulate the utility usage data so that it may be transmitted over different transport mediums and/or different communications networks and/or infrastructures). In some embodiments, utility monitoring device 110 may be integrated into a modem. In some embodiments, utility monitoring device 110 may be interfaced to communicate with the modem, such as broadband modem 125. In some embodiments, utility monitoring device 110 may be coupled with a modem via wireless and/or wire-based connections. A modem may be a broadband modem, such as broadband modem 125. In some embodiments, a modem may be a DSL modem. In some embodiments, a modem may be an optical network termination (“ONT”) device. Devices such as an ONT and DSL modem may in general provide a means for connecting to a service provider's access network. These devices in general may be referred to as access network interface devices. Utility monitoring device 110 may be a utility monitoring device of a pubic broadband network and/or a service provider's access network. A service provider's access network may include a DSL network in some embodiments. In some embodiments, a service provider's access network may include an optical network, which may include without limitation fiber to the premises (“FTTP”) architectures, fiber to the curb (“FTTC”) architectures, and fiber to the house (“FTTH”) architectures.

Utility monitoring device 110 may include or be coupled with different devices and/or components. In some embodiments, utility monitoring device 110 may include an Ethernet switch and/or a router. Switches/routers may have one or more ports. One port may connect with a Home Network. It may do so using any number of Home Networking technologies such as, merely by way of example, Ethernet over CATS cabling, MoCA over Coax, HPNA over twisted-pair, PLC over AC wiring, G.hn (currently being standardized in the ITU). Another port may connect with a data collecting device. In some embodiments, a port of utility monitoring device 110 may be configured to interface with different types of communication channel specifications. Merely by way of example, utility monitoring device 110 may be configured to interface with RS 485, EIA-485, RS 422, and/or encoder-receiver-transmitter (“ERT”), which may be used with different data collecting devices and interface components coupled with a data collecting device in order to transmit data to a receiver.

Utility monitoring device 110 may include and/or be coupled with a wireless access component and/or point (for example, a “WiFi AP”). (Although the term “WiFi” is used herein for convenience, it should be appreciated that this term includes any appropriate wireless transmission technologies, including without limitation the IEEE 802.11 suite of protocols, as well as WiMax, Bluetooth, Wireless USB, CDMA- and/or GSM-based technologies, and/or the like.) Through a WiFi AP, a utility monitoring device may receive utility usage data from a data collection device. Utility monitoring device 110 may also transmit data to a data collection device, such as utility meter 140 merely by way of example, through a WiFi AP. In other embodiments, utility monitoring device 110 may be in communication with a data collection device through a physical transmission medium. In some embodiments, utility monitoring device 110 may be in communication with a data collection device through an Ethernet and/or USB cable. In some embodiments, power may be transmitted to utility monitoring device 110 to power the devices and/or components of the access device and/or coupled with the access device through Power over Ethernet (“PoE”). Some embodiments may include utility monitoring device 110 that may receive power in numerous different ways including, but not limited to, line powering over a copper pair and/or power from a power take-off collar from a power meter.

Utility monitoring device 110 may be located exterior to a customer premises in some embodiments. A utility monitoring device may be located within a customer premises. In some embodiments, utility monitoring device 110 may communicate with numerous data collection devices associated with different customer premises.

In some embodiments, utility monitoring device 110 may comprise and/or be incorporated with a network interface device (“NID”), a term that is used in the art to describe a device that serves to demarcate a user's network (e.g., a telephone subscriber's network) from a provider's network (e.g., a telephone service provider's network). A variety of NIDs are known, including, for example, a NID that is placed on an exterior wall of the subscriber premises and serves as the gateway between the premises network (interior) and the provider's network (exterior). Several examples of such NIDs are described in U.S. Pat. Nos. 7,793,003, 7,454,006, 7,433,465, and 7,180,988, the disclosures of which are incorporated herein by reference. Any of such NIDs can be implemented as utility monitoring device 110 in accordance with various embodiments. Similarly, the various transport media described in connection with these NIDs may serve as the communication infrastructure implemented by various embodiments described herein. In some embodiments, utility monitoring device 110 may be in communication with an NID such as NID 135.

Utility usage data may be transmitted from utility monitoring device 110 to a receiving entity in different ways. Utility usage data may be transmitted through a service provider's access network. Utility usage data may be transmitted through a public switched telephone network 170. Utility usage data may be received at Public and/or Private Network 150 and then reach a receiving entity via Public and/or Private Network 150.

Embodiments may include different receiving entities, including the following with a limitation. A receiving entity may include a utility provider. A receiving entity may include a service provider that may provide access to an access network. A receiving entity may be a utility services provider that provides services to utility providers and/or utility customers. A receiving entity may also include a customer and/or user of a utility. A receiving entity may include an aggregation provider. An aggregation provider may receive utility usage data from multiple sources. Merely by way of example, an aggregation provider may aggregate data from multiple sources through a network including, but not limited to, a broadband over power line and/or mesh network and provide the aggregated data to a utility monitoring device. An aggregation provider may be an intermediate receiving entity that may receive utility usage data before another receiving entity receives the utility usage data. A receiving entity may be a third party. A third party may include but is not limited to a home owners association, a government entity, and/or a caregiver, merely by way of example.

Transmitting utility usage data from a data collecting device, such as utility meter 140 merely by way of example, to utility monitoring device 110 and then from utility monitoring device 110 to a receiving entity may be done securely. In some embodiments, the utility usage data may be encrypted. In some embodiments, utility usage data may be securely transmitted using methods, networks, and or protocols such as SSL, VPN, HTTPS and/or other known methods for securely transmitting data over different communications channels. In some embodiments, utility usage data from data collection devices may include identification information that distinguishes it from other utility usage data from other data collection devices. This may allow different utility monitoring devices and/or receiving entities to know if different data collecting devices have been successfully communicated with, and which data collecting data devices have not been communicated with, providing for alternative measures to be taken if necessary.

In some embodiments, methods may include bi-directional communication. Utility usage data, for example, may be transmitted to a receiving entity. Data may be transmitted from a receiving entity or other entity to a data collecting device. A data collecting device in communication with a PLC, for example, may send this received data to a device, appliance, or equipment also in communication with the PLC in order to control, monitor, and/or maintain the device, appliance, or equipment.

In some embodiments, a set of control data may be received at utility monitoring device 110 from a service provider's access network. The control data may be transmitted from utility monitoring device 110 to a data collecting device, such as utility meter 140 merely by way of example. The control data may be received at the data collecting device and then transmitted to at least one device in order to control, monitor, and/or maintain the device. (Alternatively, the utility monitoring device 110 may transmit such data directly to the device to be controlled, monitored and/or maintained.) In some embodiments, the control data received at the data collecting device may prompt the data collecting device to transmit utility usage data to a receiving entity. Merely by way of example, a data collecting device may need to be “woken up” before it will transmit data. Thus, in some embodiments, a receiving entity may transmit to a data collecting device a “wake up” signal, prompting the data collecting device to send data to the receiving entity, for example.

In some embodiments, a system may transmit utility usage data using a PSTN 170. The system may include a power line communications network at a customer premises. A utility meter 140 may be in communication with a power line communications network. Utility meter 140 may collect utility usage data from the customer premises. A transmission device may be in communication with utility meter 140. The transmission device may be configured to transmit automatically and securely utility usage data from utility meter 140. An access device may be in communication with the transmission device to receive the secure utility usage data. A DSL modem may be in communication with the access device. The DSL modem may be configured to securely transmit the utility usage data through a PSTN 170 to a utility provider via Public and/or Private Network 150.

In another embodiment, a system for transmitting utility usage data over a service provider's access network is provided. The system may include a utility usage data collecting device. The system may also include a broadband modem 125 in communication with the utility usage data collecting device. The broadband modem 125 may be configured to communicate with the service provider's access network and to transmit utility usage data from the utility usage data collecting device to a receiving entity.

The system for transmitting utility usage data over a service provider's access network may include a power line communications (“PLC”) network in communication with the data collecting device in some embodiments. The PLC network may provide communication between devices, appliances, and/or other equipment at a customer premises and the utility usage data collecting device.

The system for transmitting utility usage data over a service provider's access network may include a NID 135. As noted above, any of such NIDs 135 can be implemented as a remote terminal in accordance with various embodiments. Similarly, the various transport media described in connection with NIDs 135 may serve as the communication infrastructure implemented by various embodiments described herein. Broadband modem 125 may be housed within NID 135 in some embodiments.

In some embodiments, broadband modem 125 may be configured to receive control instructions from the receiving entity. Control instructions may include instructions for controlling, monitoring, and/or maintaining devices at a customer premises. Broadband modem 125 may be configured to transmit the control instructions to the utility usage data collecting device. The system may be configured to transmit the control instructions through a PLC network to a device, appliance, and/or equipment at a customer premises.

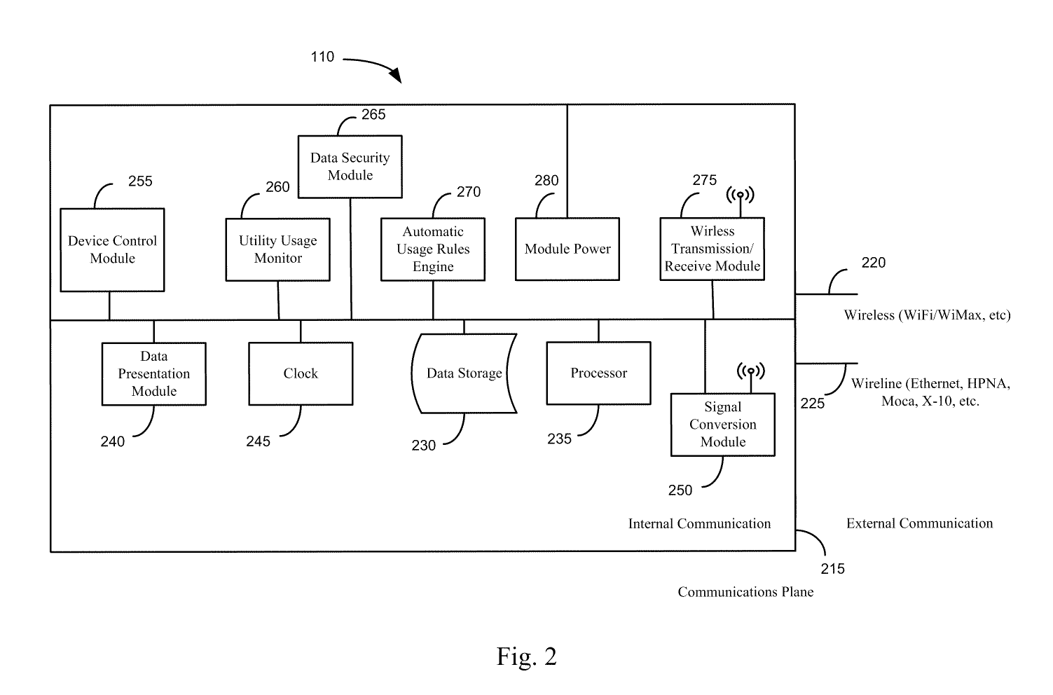

FIG. 2 shows a schematic of a utility monitoring device 110 in accordance with various embodiments. Utility monitoring device 110 may include numerous components and/or modules providing different functions and capabilities. Utility monitoring device 110 may include a communication plane 215 that may include wireless 220 and/or wireline 225 connections for coupling utility monitoring device 110 with other devices such as utility data collecting devices (such as utility meters 140 of FIG. 1, for example) or a modem or network interface device (such as broadband modem 125 or network interface device 135 of FIG. 1). Utility monitoring device 110 and different wireless and wireline connections are discussed earlier in this application for utility monitoring device 110, and may include but are not limited to WLAN (such as WiFi) and WWAN (such as WiMax) technologies for wireless connections, and Ethernet, HPNA, MoCa, and/or X-10 for wireline connections.

Utility monitoring device 110 may include data storage components 230 for storing utility data. Utility monitoring device 110 may include processor 235 for processing utility data. Some embodiments may have a variety of other components that may be referred to herein as modules. These modules are discussed throughout this application. Merely by way of example, utility monitoring device 110 may include modules or components, but is not limited to, data presentation module 240, clock 245, signal conversion module 250, device control module 255, utility usage monitor module 260, data security module 265, automatic usage rules engine module 270, power module 280, and/or wireless transmission/receive module 275.

Utility monitoring device 110 may provide several basic functions. Utility monitoring device 110 may receive and store utility usage data. This may include utility usage data for different types of utilities, such as gas, electricity, and/or water, for example. Some embodiments may be configured to receive utility usage data from individual devices at a customer premises. Utility monitoring device 110 may also monitor utility and/or device usage. By monitoring utility and/or device usage, utility monitoring device 110 may provide alerts in some instances. Utility monitoring device 110 may also provide trend and/or historical data using stored and/or current data. Utility monitoring device 110 may provide reporting capabilities based on the utility and/or device usage. Utility monitoring device 110 may also be configured to include usage rules combined with control capabilities in order to control the usage of different utilities and/or devices based on those rules. Utility monitoring device 110 may provide other more specific functions using a variety of modules and components as discussed in more detail below.

Utility monitoring device 110 may also be configured to transmit utility usage data to different receiving entities. Utility monitoring device 110 may transmit utility usage data to the consumer of the utility in some embodiments. Utility monitoring device 110 may transmit utility usage data to a utility provider in some embodiments. Utility monitoring device 110 may also transmit utility usage data to other entities, such as third parties. In some embodiments, a third party may include a government entity. In some embodiments, a third party may include a homeowners' association or a caregiver or caretaker who may be monitoring a customer premises, merely by way of example.

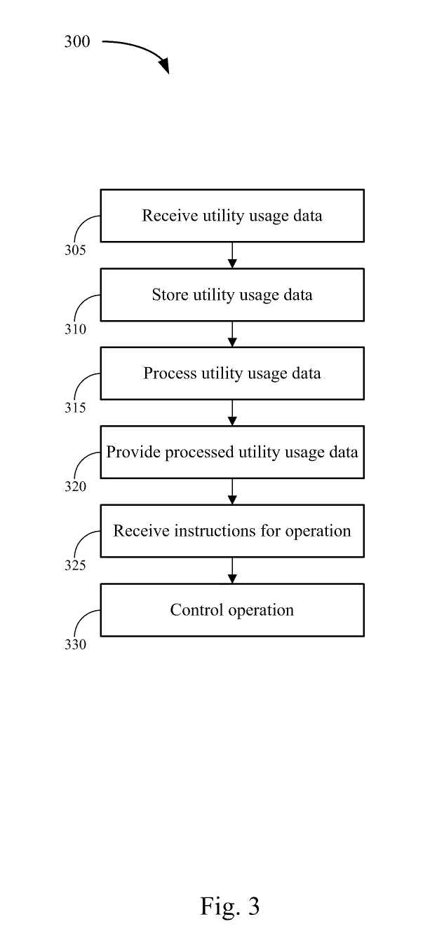

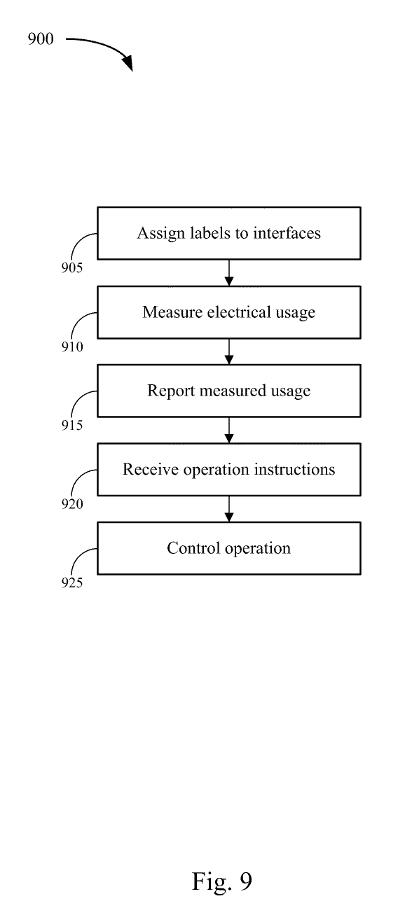

FIGS. 3 and 9 illustrate various methods that can be used to for monitoring utility usage. While the methods of FIGS. 3 and 9 are illustrated, for ease of description, as different methods, it should be appreciated that the various techniques and procedures of these methods can be combined in any suitable fashion, and that, in some embodiments, the methods depicted by FIGS. 3 and 9 can be considered interoperable and/or as portions of a single method. Similarly, while the techniques and procedures are depicted and/or described in a certain order for purposes of illustration, it should be appreciated that certain procedures may be reordered and/or omitted within the scope of various embodiments. Moreover, while the methods illustrated by FIGS. 3 and 9 can be implemented by (and, in some cases, are described below with respect to) various systems and devices described herein and/or illustrated in other figures (and/or components thereof), these methods may also be implemented using any suitable hardware implementation. Similarly, while described systems and devices (and/or components thereof) can operate according to the methods illustrated by FIGS. 3 and 9 (e.g., by executing instructions embodied on a computer readable medium), the systems and devices can also operate according to other modes of operation and/or perform other suitable procedures.

FIG. 3 illustrates a method 300 for monitoring utility usage using a utility monitoring device. The method 300 may be employed on systems such as system 100 of FIG. 1 and/or may utilize devices such as utility monitoring module 110 of FIG. 2. The method may include receiving utility usage data at the utility monitoring device (block 305). This utility usage data might be received from a metering device at a premises of a utility user, a smart device (including without limitation a smart power distribution device), and/or the like. The utility usage data may be stored on a memory within (or coupled with) the utility monitoring device (block 310). The utility usage data may be processed (e.g., using a processor coupled with or incorporated by the utility monitoring device (block 315), as described above for example, to interpret the data, reformat the data, and/or otherwise render the data suitable for presentation. In a certain embodiment, for example, processing the data might include processing the utility usage data to format the utility usage data for presentation on the at least one receiving device. As another example, processing the utility usage data may also include determining a trend in the utility usage data. Some embodiments may also include receiving rate/pricing information regarding the utility usage at the utility monitoring device along with transmitting the rate/pricing information to the at least one receiving device; processing the data might comprise calculating a cost of the utility usage, based on the details of usage (time period of usage, amount used, etc.) and the rate or pricing information.

The processed utility usage data may be provided to one or more users or other entities (block 320). Merely by way of example, in some embodiments, at least a portion of the utility usage data might be provided to a provider of the utility (e.g., using the communication interface of the utility monitoring device). In other embodiments, at least a portion of the utility usage data (which might be the same or a different portion of the data) might be provided to a subscriber of the utility, while a third portion (which again, might be the same or a different portion) might be provided to a third party. In a particular embodiment, the utility usage data might comprise data about overall utility usage, and/or data about usage by particular devices. Merely by way of example, in one embodiment, the utility monitoring device might track (and/or process and/or provide to a user) a first set of data, received from a utility meter (such as an electricity meter), which includes data about overall electricity usage for the premises, and a second set of data, received from a smart device, that includes data about electricity usage by that smart device. The utility usage data might include a plurality of sets of data received from different smart devices, including without limitation a set of data received from a smart power distribution device, which, as described in further detail below, might include utility usage data about a plurality of devices that receive electricity from the smart power distribution device.

The nature and/or presentation of the utility usage data provided by the utility monitoring device can vary by configuration options, as well as by the type of utility usage data collected. Merely by way of example, in some cases, the data may be presented as a table or list showing overall utility usage, as well as usage by a specific device. In a particular embodiment, the presentation of utility usage data might allow a particular device to be selected, which then can allow for operation instructions relating to that device to be sent to the utility monitoring device, which then may control operation of the device, as described in further detail below. As another example, the display of the utility usage data might include displaying the status (e.g., powered on, powered off, in active use, not in active use, enabled, disabled, whether any of a variety of power saving features are enabled or disabled, and/or the like) of each of one or more smart or controllable devices.

In some cases, providing the utility usage data (or a portion thereof) can comprise transmitting the data to be received by receiving device operated by a user (who might be a subscriber, a provider, or a third party). The receiving device may include devices such as personal computer, a cell phone, a mobile phone data device, a personal digital assistant (PDA), a telephone, or a television. In some embodiments, the method 300 may include transmitting the utility usage data from the utility monitoring device to a modem and/or a network interface device (unless the utility monitoring device comprises such a transmitting facility itself). Transmitting the processed utility usage data may include transmitting the utility usage data through at least a public or private network to the at least one receiving device, using a wired connection, a wireless connection, and/or the like. Some embodiments may further include receiving instructions at the utility monitoring device from the subscriber designating which subscriber device should receive the data. As noted above, providing the data can include transmitting the utility usage data and/or the processed utility usage data to the provider of the utility and/or to a third party, based on instructions received from the subscriber at the utility monitoring device. Some embodiments may include transmitting an alert to the receiving device based on the utility usage data. In some embodiments, the utility monitoring device might include an application programming interface (“API”), which could be a dedicated programming interface, an XML schema, etc., that can be used to communicate utility usage data to a provider, subscriber, and/or third party.

In other cases, providing the utility usage data (or a portion thereof) can comprise providing the data to an application (e.g., an application or applet running on a mobile device, such as a tablet, PDA, or mobile phone). In some cases, the utility monitoring device might transmit the data directly to the application (either spontaneously or based on a request from the application), while in other cases, the utility monitoring device might provide the data to an external server that subsequently provides the data to the application. Such a server might be operated by the utility provider, a third party, etc., either as a standard service or a value-added service (for which a fee might be charged).

In yet other embodiments, providing the utility usage data (or a portion thereof) might comprise providing a web interface to display the utility usage data. In some cases, the utility monitoring device (or a device such as a NID) in local communication therewith might comprise a web server that is accessible e.g., from the subscriber's local LAN and/or from the Internet (e.g., using port forwarding at the subscriber's router, etc.). In such embodiments, the subscriber (and/or the provider and/or a third party, if authorized) can access the web server to obtain the utility usage data (perhaps with appropriate access controls), which can then be displayed (e.g., in a web browser, desktop widget, web app, etc.) on the device that accessed the web server. Alternatively and/or additionally, the web server might be external to the utility monitoring device and/or the subscriber's local network, and the utility monitoring device might transmit the data to an operator of the web server, which can then allow access the data in the manner indicated above.

As noted above, data may be transmitted securely to or from a utility monitoring device and/or from a utility monitoring device to a receiving entity. Merely by way of example, in some embodiments, the utility usage data may be encrypted. In some embodiments, utility usage data may be securely transmitted using methods, networks, and/or protocols such as SSL, VPN, HTTPS and/or other known methods for securely transmitting data over different communications channels. In some embodiments, utility usage data from a data collection device may include identification information that distinguishes it from other utility usage data from other data collection devices. This may allow different utility monitoring devices and/or receiving entities to know if different data collecting devices have been successfully communicated with, and which data collecting data devices have not been communicated with, providing for alternative measures to be taken if necessary.

In some embodiments, the method 300 can include receiving instructions for operation of the utility monitoring device and/or any smart devices (including without limitation any smart power distribution devices) in communication therewith (block 325). In an aspect, the same communication techniques that are used for providing the utility usage data can be used for receiving operation instructions. Merely by way of example, if the utility monitoring device is configured to provide utility usage data via a website, the utility monitoring device might also be configured to receive operation instructions via the website (either the same webpage, a different webpage, etc). Likewise, if the utility monitoring device is configured to provide utility usage data to an application (e.g., an application running on a mobile phone), the utility monitoring device might also be configured to receive operation instructions via the same application and/or a different application. Moreover, in similar fashion to the provision of utility usage data via an API, the utility monitoring device can be configured to receive operation instructions, for example, from the utility provider and/or a third party, via an API.

In accordance with different embodiments, the utility monitoring device might support a variety of operation instructions. Merely by way of example, in some cases, the utility monitoring device supports operation instructions for the configuration of the utility monitoring device itself, such as instructions on what type of utility usage data to collect and/or provide. In other cases, the utility monitoring device might support instructions for controlling operation of one or more smart devices in communication with the utility monitoring device. The type of control that can be implemented often will be dependent on the functionality of the smart device itself. Merely by way of example, some smart devices might allow external control to power on (or otherwise enable) or power off (or otherwise disable) the device, instructions to implement utility-saving features in the device, etc.; operational instructions for such functions therefore might be supported by the utility monitoring device. In other cases, a smart appliance, such as a water heater, might provide additional controls, such as the ability to control the thermostat, and the utility monitoring device might support operation instructions to control these features as well.

As noted above, in some embodiments, the utility monitoring device can display, as part of the utility usage information, a status of each of one or more controllable and/or smart devices. In such embodiments, the user interface (whether provided by an application, a webpage, or otherwise) might allow the user to select that status (or otherwise select the controllable device) within the user interface. Based on selection of the device, the user interface might display options for the control of that device, and selection of one of the options might result in the receipt by the utility monitoring device of the corresponding operation instruction.

In the case of a smart power distribution device, the utility monitoring device might support operation instructions for controlling one or more outlets of the smart power distribution device, for controlling data collected and/or transmitted by the smart power distribution device, and/or for controlling any other advanced features of the smart power distribution device, including without limitation those described in further detail below.

In some embodiments, therefore, the method 300 might further comprise controlling operation of the utility monitoring device and/or one or more smart/controllable devices in communication therewith (block 330). In an aspect of some embodiments, the utility monitoring device controls operation of a smart device in response to receiving operation instructions, for example, as described above. Upon receiving such instructions, the utility monitoring device might interpret the instructions to determine a corresponding instruction to transmit to the appropriate smart device, might format such an instruction, and/or my transmit instruction (using whatever communication facility is implemented between the smart device and the utility monitoring device) for reception by the Smart device, which then modifies its operation in accordance with the instruction received from the utility monitoring device.

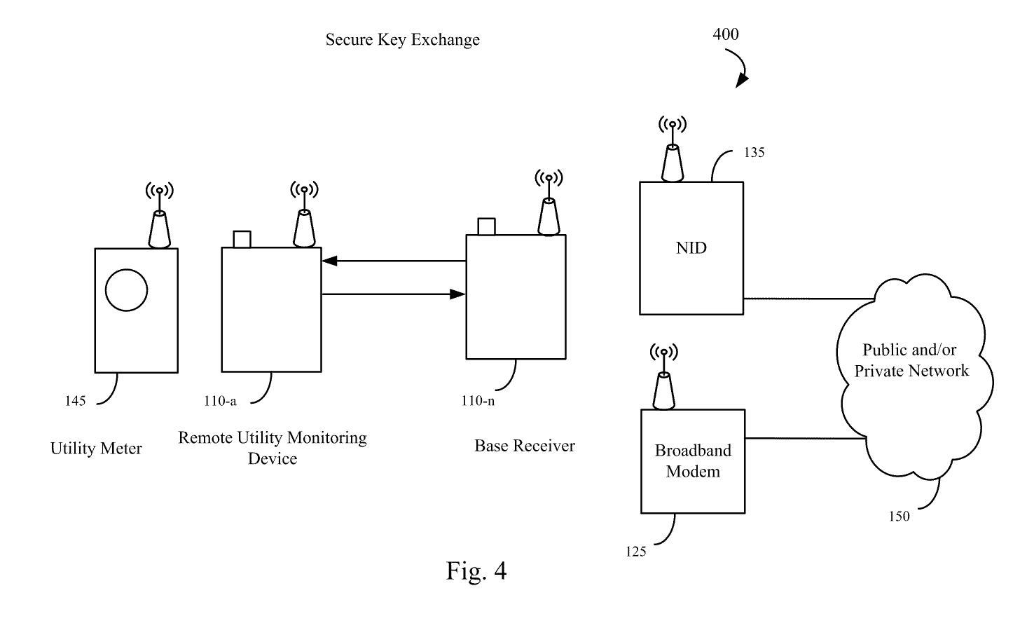

FIG. 4 shows system 400 that may include one or more utility monitoring devices 110 that may include data security modules. A data security module may include data security module 265 of FIG. 2. Data security modules may be implemented within different systems such as system 100 of FIG. 1 and/or utility monitoring device 110 of FIG. 2. Some embodiments may include a utility monitoring device 110-a associated with a customer premises or utility meter 145. This may be referred to as a remote utility monitoring device. System 400 also shows a base utility monitoring device 110-n, which may be referred to as a base receiver. In some embodiments, base receiver 110-n may be a network interface device (NID). Base receiver 110-n may be coupled with other communication devices such as NID 135 or broadband modem 125, via wireless and/or wireline connection. NID 135 and/or broadband modem 125 may be further in communication with Public and/or Private Network 150.

Data security modules may be configured to secure private transmission of utility usage data. This may be done in a variety of ways. For example, data transmitted from remote utility monitor device 110-a to base receiver 110-n may be encrypted. The encryption may utilize either public and/or private keys. These may involve symmetrical and/or asymmetrical encryption. Some embodiments may involve the secure exchange of keys. Remote utility monitoring device 110-a and/or base receiver 110-n may be configured to exchange respective keys when each device is prompted to do so. This may involve physically triggering each device, such as through pushing a button or turning a switch. In other embodiments, the exchange may occur when signals are transmitted to each device. In some cases, this may be an automated process.

Data security modules may be configured to provide several different functions with respect to providing secure data transmission between devices. For example, data security modules may include initialization functionality to set up an initial process of exchange keys between devices. Data security modules may also include reset functionality that may prompt the exchange of new keys. For example, new keys may be exchanged on a regular basis, or when there may be concern that the keys may have been intercepted by a third party.

Data security modules may allow for the exchange of keys between remote utility monitoring devices 110-a and base receivers 110-n. In some cases, multiple remote utility monitoring devices 110-a may exchange keys with one centralized base receiver 110-n. In some embodiments, remote monitoring devices 110-a and/or base receivers 110-n may also exchange keys with other devices and/or entities. For example, utility provider systems and/or devices and some third party devices and/or systems may also exchange keys with remote utility monitoring devices 110-a and/or base receivers 110-n to provider for further encryption between different communication points.

Data security modules may assign keys to different devices and/or systems. Merely by way of example, keys may be assigned to individual customer premises. Such a key may be assigned to a remote utility monitoring device 110-a associated with the customer premises. In some embodiments, individual devices within or associated with a customer premises may be assigned keys. Base receiver 110-n may be assigned keys. NID 135 and/or broadband modem 125 may be assigned keys. In some embodiments, third parties and/or utility provider systems and/or devices may be assigned keys.

In some embodiments, devices such as remote utility monitoring device 110-a and/or base receiver 110-n may generate their own keys. In some embodiments, keys may be generated elsewhere and then transmitted or otherwise delivered and stored on these devices and/or systems.

Data security modules may utilize keys to securely transmit data between different devices in systems such as that seen in FIG. 4. The keys may be used to validate the data being transmitted through system 400. Systems utilizing data security modules may also be utilized to identify data coming from specific premises and/or devices. Data security modules may be used to encrypt the data, both transmitted and received from devices such as remote utility monitoring module.

Systems such as system 400 using data security module may also decrypt data using these secure key exchange methods at different points. Data may be decrypted at remote utility monitoring device 110-a, base receiver 110-n, and/or at a location of utility providers and/or third parties. In some case, multiple keys may be utilized along the path from a first device, such as a device within a customer premises, to a final location, such as utility provider.

Systems such as system 400 may also include a heartbeat module (not shown) as part of different devices such as remote utility monitoring device 110-a and/or base receiver 110-n. Heartbeat modules may regularly exchange messages between devices. This regular exchange of messages provides an acknowledgment system to insure that no jamming or interference is occurring. This may aid in improving the security of some systems that may also be using data security modules.

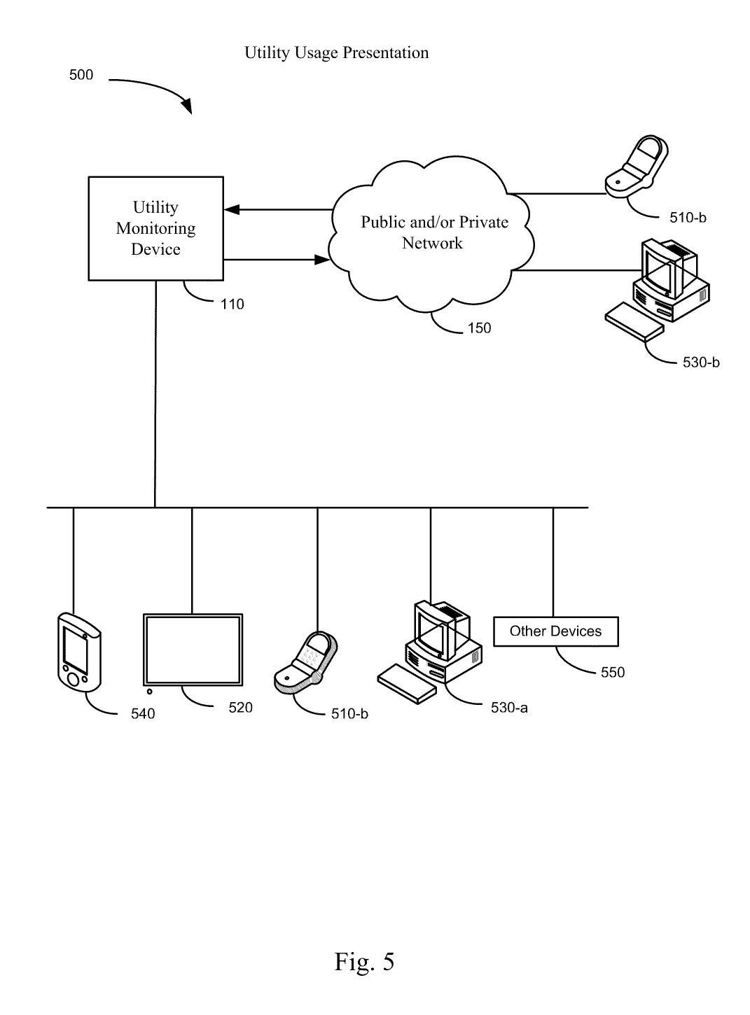

FIG. 5 shows a system 500 for utilizing a utility monitoring device 110 that includes a utility usage presentation module, such as data presentation module 240 of FIG. 2. FIG. 5 shows several different components that may make up a system such as system 500, including utility monitoring device 110, Public and/or Private Network 150, receiving entity devices, such as cell phone 510-a, 510-b, television 520, computers 530-a, 530-b, PDA 540, or other devices 550. Utility usage presentation modules may be configured to present information such as utility usage to a consumer, a utility provider, and/or a third party, merely by way of example. Utility usage presentation modules may provide data on the present, past, and projected future use of a utility for a customer premises. In some embodiments, utility usage presentation modules may provide information regarding the usage of a utility by specific devices within a customer premises.

In some embodiments, utility usage presentation modules may be configured to provide options for turning specific devices at a customer premises on and/or off. Some embodiments may allow this process to be automated. For example, utility usage presentation modules may be configured to turn specific devices on and/or off based on the utility usage of the specific device, utility usage for a customer premises, or other factors. Merely by way of example, utility usage presentation modules may turn devices on and/or off based on the cost of a utility usage.

In some embodiments, utility usage presentation modules may format the presentation of utility usage information for different devices. For example, utility usage presentation modules may format for presentation on computer screen 530-a, 530-b, cell phone 510-a, 510-b, television 520, PDA 540, or other devices 550, merely by way of example. Utility usage presentation modules may be configured to present information to different devices based on preferences of a user and/or characteristics of the devices.

In some embodiments, utility usage presentation modules may present different types of data. Merely by way of example, utility usage presentation modules may present current utility usage data. Current utility usage data may be based on specific utility usage, such as water, gas, and/or electric. Current utility usage data may also be presented for specific devices that are utilizing a specific utility. For example, utility usage for devices such as a dishwasher, a heater, or others may be provided. In some cases, these devices may be smart devices or coupled with devices that provide for individual measure of utility usage of the device.

Some embodiments may present historical usage data. Historical utility usage data may be based on specific utility usage, such as water, gas, and/or electric. Historical utility usage data may also be presented for specific devices that are utilizing a specific type of utility. Some embodiments may also provide trend data, which may take historical and/or current data and make projections and/or predictions for future usage.

In some embodiments, utility usage presentation modules may present costs of a utility usage. This may include costs based on current costs and/or past costs. Current and/or past cost data may also be used to determine trends regarding cost that may be presented. Embodiments may present individual costs for a utility, such as price per kilowatt-hour, merely by way of example. Some embodiments may also determine actual costs based on usage and/or provide costs for different time periods, such as per day, per hour, per week, per month, merely by way of example. Some embodiments may utilize utility costs and prices along with utility usage data to present information that a user may utilize to make decisions about current or future usage of a utility.

In some embodiments, utility usage presentation modules may present information regarding carbon footprints for utility usage. Utility usage presentation modules may determine the amount of carbon introduced into the atmosphere based on individual and/or overall utility usage. Different carbon footprints may also be determined for different types of utilities, such as for water, gas, and/or electricity, and/or for specific devices. In some embodiments, carbon footprints may be determined for individual utility users at a premises.

In some embodiments, utility usage presentation modules may provide different presentations options. Merely by way of example, utility usage presentation module may provide presentation information based on user profiles. In some embodiments, a user profile may be utility specific. User profiles may also include different profiles for different individuals within a customer premises. User profiles may also be determined for different types of devices, such as entertainment, major household appliances, room-specific devices, such as kitchens, merely by way of example.

In some embodiments, utility usage presentation modules may also include one or more rules engines. A rules engine may provide for when, where, and/or how a specific device and/or multiple devices are used. Users may set up rules to be utilized by the rules engine. In some embodiments, other entities may provide rules, either as suggested and/or as mandatory rules.

Utility usage presentation modules may also provide for the presentation of utility bills. Bill payment may be done for different utilities, such as gas, water, and/or electricity. Utility usage presentation modules may provide a utility bill that determines how much of a utility bill is associated with different presentation information that utility usage presentation modules may have generated.

Utility usage presentation modules may also include alert functions. Alerts may be presented for a variety of reasons. Merely by way of example, an alert may be sent when a specific utility usage is exceeded. Alerts may also be presented when specific devices are turned on and/or off. Alerts may be presented when the cost of a utility changes; for example, an alert may be presented when the cost of a utility exceeds a pre-determined level that may be set by a user. In some embodiments, utility usage presentation modules may also present an alert when it determines a price change that may be relevant to a user, without the user necessarily providing a pre-determined level.

Utility usage presentation modules may also include security features. Merely by way of example, data that may be transmitted to different devices may be encrypted to protect the information for determined by other parties. Other modules discussed above may provide for other security functions and may be integrated into utility usage presentation modules.

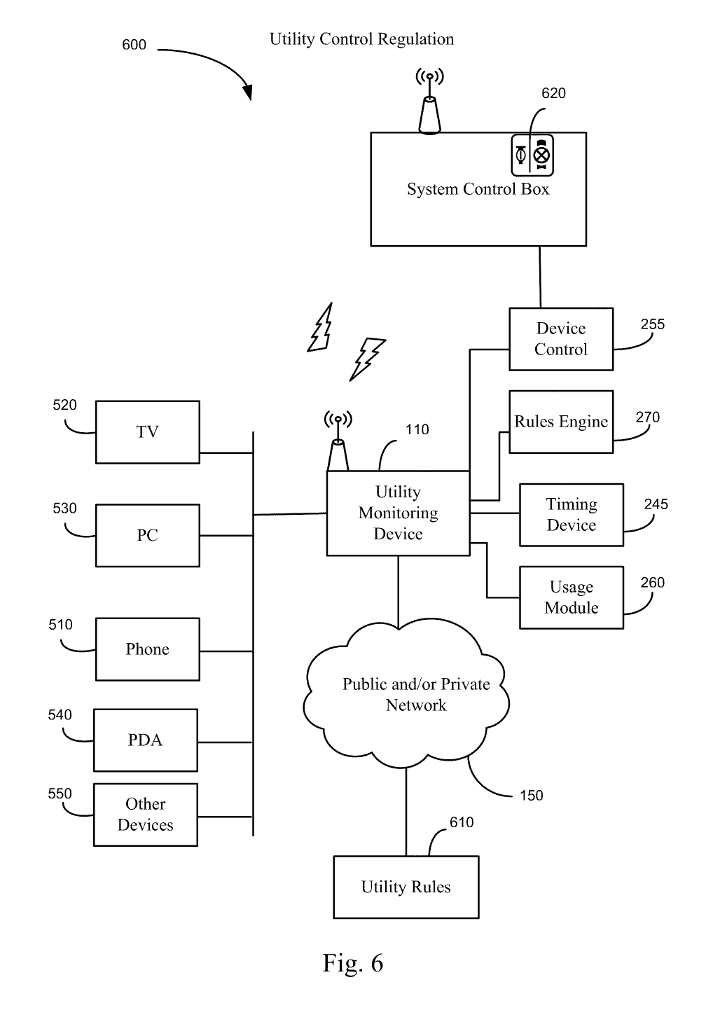

FIG. 6 shows system 600 utilizing a utility monitoring device 110 that includes a utility control regulation module, such as may include using modules such as a device control module 255, a utility usage module 260, a timing device 245 such as a clock, and/or an automatic usage rules engine module 270 of FIG. 2, merely by way of example. A utility control regulation module may provide control over devices at a premises based on different utility rules and regulations. Merely by way of example, a utility control regulation module may control the use of different devices and/or amounts of a utility that are utilized based on local, state, and/or federal regulations. For example, local regulations may regulate when a person may water his or her lawn. Merely by way of example, local regulations may permit watering only after sundown and before sunrise. In another example, a government regulation may impose restrictions on a utility's use, such as electricity, when demand exceeds a certain point. A utility control regulation module may thus control when or how much watering occurs or electricity is used. In some embodiments, a utility control regulation module may be used to prohibit utility usage in some instances, such as water, gas, or electricity usage. In other embodiments, a utility control regulation module may be used to schedule when a utility is used in order to conform with the regulation.

Some embodiments may also in effect implement other regulations from other entities besides government regulations. For example, a utility provider may also impose different regulations regarding utility use. In some cases, a home owners association (HOA) may impose regulations on those who live within the HOA. And in other cases, individual consumer and/or third parties may impose their own regulations and/or decision rules regarding when, how, and/or where a utility is used.

A utility control regulation module may provide a variety of functions. A utility control regulation module may acquire regulations and/or rules from different sources. Merely by way of example, a utility control regulation module may receive regulations and/or rules, such as utility rule 610, merely by way of example, over different communication means, such as over Public and/or Private Network 150. Regulations and/or rules may also be manually entered. A utility control regulation module may also store the regulation and/or rule information in a storage medium. A utility control regulation module may also update regulations for systems on a regular basis.

In some embodiments, a utility control regulation module may provide alerts when a rule or regulation is violated. The violation may be presented to the user in some cases. In some embodiments, the alert may be sent to devices including, but not limited to, television 520, computer 530, telephone 510, PDA 540, and/or other devices 550. Some embodiments may send the alert to a utility provider and/or a government entity, which in some cases may be an enforcement branch of the government entity. In some embodiments, one or more devices may automatically be turned off when an alert is made. Some embodiments may allow for the continued use a utility even if an alert has been sent. A user may configure some embodiments to allow for this continued use even after an alert is sent and possibly acknowledged.

A utility control regulation module may provide access to different individuals and/or entities to determine which rules and/or regulations to implement. Merely by way of example, a user of the utility such as a customer at a premises may make decisions regarding which rules and/or regulations to follow and/or other matters regarding usage. In some embodiments, a third party may be given access. For example, a caregiver or caretaker may be provided access. Utility providers and/or government entities may also be provided access. Some embodiments may allow for neighborhood access and/or control. For example, an HOA may be provided access to control when devices are used. This may be used to aid in avoiding the HOA violating some rules or/or regulations, or to implement the HOA's own policies. Some embodiments may also allow for a round robin idea, where different utility monitoring devices with utility control regulation modules may determine when to use a specific device and/or utility based on what the other utility control devices with utility control regulation modules are doing. This may be used to optimize the use of resources, for example, or to insure that a group of premises such as those within an HOA do not put excessive demands on a resource, such as electricity or water, merely by way of example. Utility control regulation modules may also be configured to provide incentives to users in how they use different utilities.

Some embodiments of a utility control regulation module may also include reset capabilities. For example, utility control regulation modules may reset different parts of a system, such as automated systems like water sprinkler systems, when there is a utility outage, such as an electricity outage. Some embodiments may provide reset functions when other events occur, such as different weather conditions, such as excessive rain, which may result in a system needing to override a scheduled timing system.

Some embodiments may also include specific control devices and/or modifications of devices in order to allow for the control of such devices. FIG. 6. shows system control box 620, for example, that may be utilized to implement utility control regulations and/or rules.

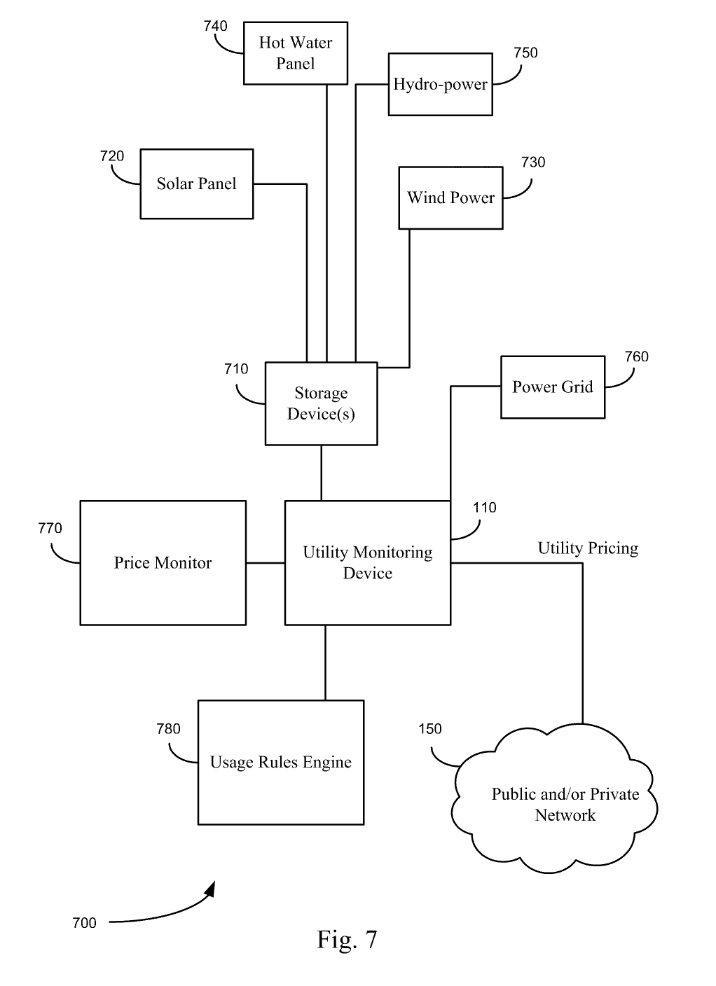

FIG. 7 shows system 700 utilizing utility monitoring device 110 that may include a utility sell-back and/or buy-back module. System 700 may include one or more storage devices 710 that may store a utility. Merely by way of example, storage devices 710 may include devices that may store electricity, such as batteries and/or fuel cells. Some embodiments may store other forms of energy, such as thermal energy. Some embodiments may be configured to produce other forms of energy that may be stored. For example, some systems may include means for generating hydrogen. System 700 may also include different means for producing a utility. For example, system 700 may include photovoltaic cells 720, wind generators 730, hot water panels 740, hydro-power generators 750, and/or other means of generating a utility. In some embodiments, a utility resource produced by a utility generator may be stored using one or more of the storage devices 710. In some embodiments, a utility may be produced by other sources, such as a utility provider, which is then stored in one or more of utility storage devices 710. For example, system 700 may be coupled with power grid 760 in different ways to allow for power to be stored on storage devices 710.

Utility sell-back and/or buy-back modules may be utilized in a variety of ways. For example, a utility may be generated using one of a utility producing means (such as 720, 730, 740, and/or 750) or may be received from another source (such as power grid 760) and then stored using utility storage device 710. Utility sell-back and/or buy-back modules may monitor utility pricing using price monitor 770. Utility pricing information may be received in different ways, including Public and/or Private Network 150. Utility sell-back and/or buy-back modules may make determinations to sell a utility that is produced and/or stored in system 700 based on the price of the utility. This may involve usage rules engine 780, which may aid in making this determination. In some embodiments, a utility sell-back and/or buy-back module may determine to buy a utility based on the monitored price and then either store or utilize the utility. Some embodiments may monitor the utility pricing from different sources, such as public utility providers and/or other providers that may include other producers of a utility. A utility sell-back and/or buy-back module may provide a utility to different possible buyers, from utility providers to individual customers. Some embodiments may include means for notifying and/or advertising that system 700 can provide a utility, such as gas, water, or electricity, merely by way of example.

Utility sell-back and/or buy-back modules may include usage rules engine 780. Usage rules engine 780 may make different determinations regarding when to buy and sell a utility that may be stored and/or produced at a customer premises and/or multiple customer premises. For example, determinations may be made based on a current, past, or predicted cost of a utility. In some cases, a determination may be made based on how much of a utility is stored within utility storage devices 710. In some cases, a determination may be made based on how much capacity is available to store a utility within the utility storage devices 710. Merely by way of example, usage rules engine 780 may determine to sell electricity when more electricity is being produced and/or stored than a premises may need. Some embodiments may store a utility such as electricity until a certain price for the utility is reached. In some embodiments, usage rules engine 780 may purchase utility for other sources at a low price and store it until the utility can be sold at a higher price.

Some embodiments may allow multiple premises to combine together to take advantage of the utility sell-back and/or buy-back modules. Merely by way of example, a home owners association may utilize one or more utility monitoring devices 110 with usage rules engines 780 to distribute a utility between different premises based on the individual production and storage capacities of each premises, along with the needs of each premise. A collection of such premises then may collectively determine when and how to store, sell, and/or buy different utilities.

As noted above, some embodiments include a smart power distribution device. In one aspect, a smart power distribution device can be any device that distributes electricity (or any other appropriate utility) to one or more devices that may not be smart devices themselves. In this way, a smart power distribution device can essentially provide smart device-like functionality for non-smart devices. Merely by way of example, the smart power distribution device can track and/or control utility usage (e.g., current, power, etc.) by the non-smart device, and/or can report such usage, e.g., to utility monitoring device or similar device. In the case of electricity distribution, the smart power distribution device can also provide other functionality, such as surge protection, battery backup, and or the like; thus, in some embodiments the smart power distribution device can serve as a “power strip,” a battery backup system, and/or similar device, but with enhanced functionality.

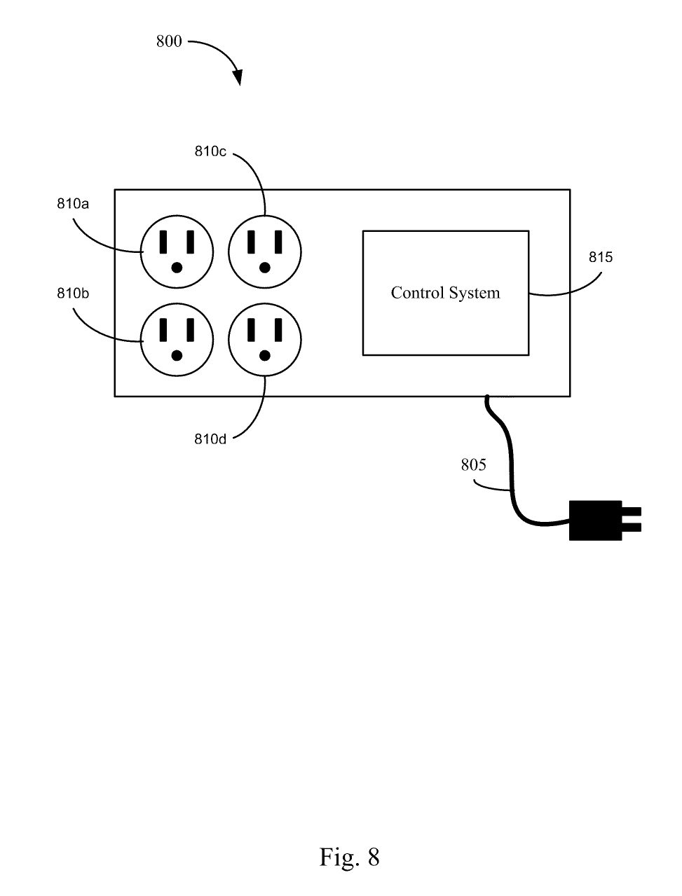

FIG. 8 illustrates a smart power distribution device 800, in accordance with one set of embodiments. The illustrated smart power distribution device 800 is designed to distribute electricity among one or more connected devices, although different embodiments might distribute one or more different types of utilities.

The smart power distribution device 800 comprises an electrical input interface 805, which might be configured to receive electricity from a standard electrical wall socket. Merely by way of example, the electrical input interface might comprise a standard, three-pronged plug attached to a cord, for receiving standard AC current (e.g., 5A, 10A, etc., at 110V, 220V, 240V, etc.). The smart power distribution device 800 further comprises one or more electrical output interfaces 810; as illustrated, the smart power distribution device 800 includes four electrical output interfaces 801a-810d, although the number of interfaces is discretionary and is limited only by the available space, input current, and/or output current. Such electrical output interfaces 801 can take any of a variety of forms, including without limitation AC output interfaces (e.g., comprising a standard three-pronged socket), DC output interfaces, such as 12V automotive output interfaces, USB output interfaces, etc. (in which case the smart power distribution device might 800 might further comprise any necessary transformers, rectifiers, and/or the like, which are known in the art). The electrical output interfaces 810 are in communication with the electrical input interface 805 in the manner of a standard power strip, such that electricity received through the input interface 805 can be distributed to other devices through the output interfaces 810.

The smart power distribution device 800 further comprises a control system 815. In one embodiment, the control system 815 is a computing system (which may comprise a microcontroller, etc.), and it might include appropriate hardware and/or software for controlling operation of the smart power distribution device 800. Such hardware can include, without limitation, a communication interface to provide communication between the smart power distribution device 800 and other devices (such as a utility monitoring device, a personal computer, and/or the like). The communication interface can include any appropriate wired and/or wireless medication facilities, including without limitation those described elsewhere herein. The control system might further comprise a processor in communication with the communication interface, and/or memory in communication with the processor. The memory might have encoded thereon code for controlling operation of the control system 815 and/or smart power distribution device 800 overall. In particular, such operation might include monitoring and/or controlling the usage of electricity by one or more devices that receive electricity from the smart artist vision device, storing electoral usage data about site usage, reporting such data to another device (such as a utility monitoring module), and/or receiving operation instructions from such another device. In particular embodiments, the smart power distribution device might provide its own user interface (e.g., via a keypad, display, etc. on the smart power distribution device, via a webserver and/or API provided by the smart power distribution device, etc.); in other embodiments, the smart power distribution device might receive operation instructions from another device, such that it need not include its own user interface.

FIG. 9 illustrates a method 900 that may be performed by a smart power distribution device, in accordance with one set of embodiments. In one embodiment, the method 900 comprises assigning a label to each of one or more of the electrical output interfaces (block 905). In an aspect, the label can be used to identify the device is plugged into that output interface. So, for example, if a coffee makers plug into one of the output interfaces, that interface might be labeled “coffee maker.” Similarly, if a stereo receiver is plugged into another one of the output interfaces, that interface may be labeled “stereo.” In this way, when the electoral usage of that device is monitored, reported, and/or controlled, the subscriber (or another) can easily understand what device is being monitored, reported, and or controlled. In an aspect, these labels are stored in a memory at the smart power distribution device, and can be reset or reassigned through operational instructions provided to the smart power distribution device (e.g., a utility monitoring device, a computer system, or other device in communication with the smart power distribution device, and/or through direct interaction by a user with the user interface provided by the smart power distribution device itself).

In some embodiments, the method 900 further comprises measuring electrical usage of one or more devices that receive electricity from the smart power distribution device. In an aspect, the control system smart power distribution device includes an interface to the power circuits between the electrical input interface and each of the electrical output interfaces; by measuring current passing through this interface, the smart power distribution device can measure the current drawn by each of the output interfaces. The method 900, then, can further comprise storing these measurements (which can be considered utility usage data) and/or reporting this utility usage data (block 915), e.g., to a utility monitoring device, a computer system, etc., using the communication interface of the smart power distribution device; and/or via the smart power distribution device's own user interface. In an aspect, when the utility usage data for a particular output interface is stored and/or reported, that data is correlated with a label for that interface, to facilitate interpretation of the utility usage data. The utility usage data might be provided on a scheduled basis, in response to a request from a requesting device or the user interface, etc.

At block 920, the method 900 comprises receiving operation instructions (e.g., via the communication interface and/or from a utility monitoring device, computer system, etc.; and/or directly via the smart power distribution device's own user interface). The operation instructions might configure the operation of the smart power distribution device itself (e.g., instructions on reassignment of labels to output interfaces, instructions on what parameters to monitor and/or report, instructions on where to provide reports, etc.). In other cases, the operation instructions might pertain to control over one or more of the electrical output interfaces (and/or the devices receiving electricity from those interfaces). Merely by way of example, the operation instructions might include instructions to disable one or more of the output interfaces (e.g., by interrupting the flow of electricity to those interfaces), to enable one or more output interfaces (e.g., by resuming the flow of electricity to those interfaces, etc.). At block 925, the smart power distribution device controls operation of one or more of the attached device(s), in accordance with the operation instructions, e.g., by controlling electrical current supplied to the output interface(s).

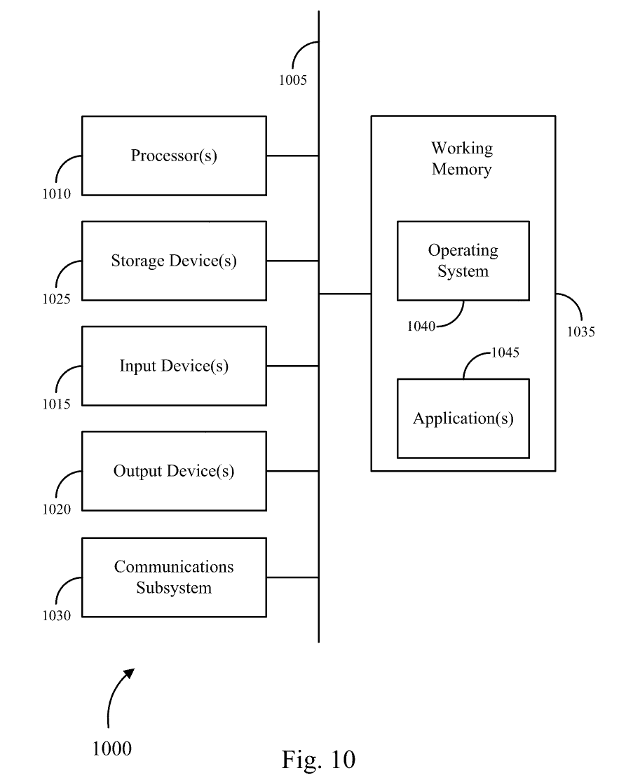

FIG. 10 provides a schematic illustration of one embodiment of a computer system 1000 that can perform the methods provided by various other embodiments, as described herein, and/or can function as a utility monitoring device, a control system for a smart power distribution device, and/or the like. It should be noted that FIG. 10 is meant only to provide a generalized illustration of various components, of which one or more (or none) of each may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a mouse, a keyboard and/or the like; and one or more output devices 1020, which can include without limitation a display device, a printer and/or the like.

The computer system 1000 may further include (and/or be in communication with) one or more storage devices 1025, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 1030 may permit data to be exchanged with a network (such as the network described below, to name one example), with other computer systems, and/or with any other devices described herein. In many embodiments, the computer system 1000 will further comprise a working memory 1035, which can include a RAM or ROM device, as described above.

The computer system 1000 also may comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 1025 described above. In some cases, the storage medium might be incorporated within a computer system, such as the system 1000. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1000) to perform methods in accordance with various embodiments of the invention. According to a set of embodiments, some or all of the procedures of such methods are performed by the computer system 1000 in response to processor 1010 executing one or more sequences of one or more instructions (which might be incorporated into the operating system 1040 and/or other code, such as an application program 1045) contained in the working memory 1035. Such instructions may be read into the working memory 1035 from another computer readable medium, such as one or more of the storage device(s) 1025. Merely by way of example, execution of the sequences of instructions contained in the working memory 1035 might cause the processor(s) 1010 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 1000, various computer readable media might be involved in providing instructions/code to processor(s) 1010 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 1025. Volatile media includes, without limitation, dynamic memory, such as the working memory 1035. Transmission media includes, without limitation, coaxial cables, copper wire and fiber optics, including the wires that comprise the bus 1005, as well as the various components of the communication subsystem 1030 (and/or the media by which the communications subsystem 1030 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000. These signals, which might be in the form of electromagnetic signals, acoustic signals, optical signals and/or the like, are all examples of carrier waves on which instructions can be encoded, in accordance with various embodiments of the invention.

The communications subsystem 1030 (and/or components thereof) generally will receive the signals, and the bus 1005 then might carry the signals (and/or the data, instructions, etc. carried by the signals) to the working memory 1035, from which the processor(s) 1005 retrieves and executes the instructions. The instructions received by the working memory 1035 may optionally be stored on a storage device 1025 either before or after execution by the processor(s) 1010.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system, comprising:
a monitoring device for providing utility monitoring services, the monitoring device comprising:
a first communication interface;
a first processor in communication with the first communication interface; and
a first memory in communication with the first processor, the first memory having stored therein a first set of machine readable code executable by the first processor to cause the monitoring device to perform one or more operations, the first set of machine readable code comprising:
code for receiving a first set of utility usage information;
code for processing the utility usage information;
code for providing at least a portion of the processed utility usage information to a subscriber of the utility; and
code for providing at least a portion of the utility usage information to a provider of the utility; and
a smart power distribution device in communication with the monitoring device, comprising:
an electrical input interface configured to receive electricity from a standard electrical wall socket;
one or more electrical output interfaces configured to provide electricity to one or more client devices via standard electrical plugs;
a second communication interface configured to provide communications with the monitoring device;
a second processor in communication with the second communication interface; and
a second memory in communication with the second processor, the second memory having stored therein a second set of machine readable code executable by the second processor to cause the smart power distribution device to perform one or more operations, the second set of machine readable code comprising:
code for measuring electrical usage of at least one of the one or more client devices;
code for reporting, via the communication interface, the measured electrical usage of the at least one of the one or more client devices;
code for receiving, via the communication interface, instructions on operation of the at least one of the one or more client devices; and
code for controlling an electrical current supplied to at least one of the one or more electrical output interfaces, in response to the instructions.

2. A monitoring device for providing utility monitoring services, the monitoring device comprising:
a communication interface;
a processor in communication with the communication interface; and
a memory in communication with the processor, the memory having stored therein a set of machine readable code executable by the device to perform one or more operations, the machine readable code comprising:
code for receiving, from a utility meter, a first set of utility usage information;
code for processing the utility usage information;
code for providing at least a portion of the processed utility information to a subscriber of the utility;
code for providing at least a portion of the utility usage information to a provider of the utility; and
code for providing at least a portion of the utility usage information to a third party separate from the subscriber and the provider.

3. The monitoring device of claim 2, wherein the code for providing at least a portion of the processed utility information to a subscriber of the utility comprises code for providing the at least a portion of the processed utility information to an application running on a mobile telephone.

4. The monitoring device of claim 3, wherein the code for providing the at least a portion of the processed utility information to an application running on a mobile telephone comprises code for providing the at least a portion of the processed utility information to an external server in communication with the application running on the mobile telephone.

5. The monitoring device of claim 2, wherein the code for providing at least a portion of the processed utility information to a subscriber of the utility comprises code for providing a web interface to display the at least a portion of the processed utility information in a web browser or desktop widget.

6. The monitoring device of claim 2, wherein the machine readable code further comprises:
code for receiving, from one or more smart devices, a second set of utility usage information, the second set of utility usage information comprising data about utility consumption of the smart device.

7. The monitoring device of claim 6, wherein the machine readable code further comprises:
code for controlling operation of at least one of the one or more smart devices.

8. The device of claim 6, wherein the smart device is a power distribution device that receives electrical power and distributes the electrical power to one or more non-smart devices, and wherein the utility consumption of the smart device comprises the electrical power distributed to the one or more non-smart devices.

9. The monitoring device of claim 2, wherein the utility usage information comprises information about consumption of one or more utilities selected from the group consisting of electricity, water, and natural gas.

10. The monitoring device of claim 9, wherein the information about consumption comprises information about one or more parameters selected from the group consisting of quantity used, rate of use, and time period of use.

11. The monitoring device of claim 2, wherein the monitoring device is incorporated within a set-top box.

12. The monitoring device of claim 2, wherein the monitoring device is incorporated within a telephony network interface device.

13. The monitoring device of claim 2, wherein the communication interface provides connectivity with a private or public network.

14. The monitoring device of claim 2, wherein the communication interface comprises a broadband modem.

15. The monitoring device of claim 2, wherein the communication interface comprises a wireless communication interface.

16. The monitoring device of claim 2, wherein the machine readable code further comprises:
code for receiving, via the communication interface, instructions for operation of the monitoring device.

17. The monitoring device of claim 16, wherein the instructions for operation of the device comprise instructions to disable a smart device in communication with the monitoring device.

18. The monitoring device of claim 16, wherein the instructions are received from the provider.

19. The device of claim 16, wherein the instructions are received from the subscriber.

20. The monitoring device of claim 19, wherein the code for receiving instructions for operation of the device comprises code for providing a web interface to receive user instructions for operation of the device.

21. The monitoring device of claim 19, wherein the code for receiving instructions for operation of the device comprises code for receiving the instruction for operation from an application running on a mobile telephone.

22. The monitoring device of claim 20, wherein the web interface comprises a list of smart devices and information about a status of each of the smart devices.

23. A smart power distribution device, comprising:
an electrical input interface configured to receive electricity from a standard electrical wall socket;
one or more electrical output interfaces configured to provide electricity to one or more devices via standard electrical plugs;
a communication interface configured to provide communications with a utility monitoring device;
a processor in communication with the communication interface; and
a memory in communication with the processor, the memory having stored therein a set of machine readable code executable by the smart power distribution device to perform one or more operations, the machine readable code comprising:
code for measuring electrical usage of at least one of the one or more devices;
code for reporting, via the communication interface, the measured electrical usage of the at least one of the one or more devices;
code for receiving, via the communication interface, instructions on operation of the at least one of the one or more devices; and
code for controlling an electrical current supplied to at least one of the one or more electrical output interfaces, in response to the instructions.

24. The smart power distribution device of claim 23, wherein the machine readable code further comprises:
code for assigning a label to at least one of the one or more electrical output interfaces, the label identifying a device receiving power from the at least one electrical output interface.

25. A method of utility monitoring, comprising:
receiving, from a utility meter, a first set of utility usage information;
processing the utility usage information at a utility monitoring device;
providing at least a portion of the processed utility information to a subscriber of the utility;
providing at least a portion of the utility usage information to a provider of the utility; and
providing at least a portion of the utility usage information to a third party separate from the subscriber and the provider.
